(19) United States
(12) Patent Application Publication
(10) Pub. No.: US 2019/0213602 A1
(43) Pub. Date: Jul. 11, 2019

(54) COMPLAINT RESOLUTION SYSTEM

(71) Applicant: GRIPEVINE INC., Oakville (CA)

(72) Inventors: Richard HUE, Oakville (CA); Robert RAMAGE, Puslinch (CA)

(21) Appl. No.: 16/325,828

(22) PCT Filed: Aug. 15, 2017
(86) PCT No.: PCT/CA2017/050965

§ 371 Date: Feb. 15, 2019

Related U.S. Application Data
(60) Provisional application No. 62/475,447, filed on Mar. 23, 2017.
(60) Provisional application No. 62/375,027, filed on Aug. 15, 2016.

(51) Int. Cl. G06Q 30/00; H04L 12/58; G06Q 30/02; G06F 21/31

(52) U.S. Cl. CPC G06Q 30/016; H04L 51/32; G06F 21/31; H04L 51/18; G06Q 30/0282; H04L 51/046

(57) ABSTRACT

A method and system for determining metrics are provided. An issue associated with an entity and received from an end-user account via the computer system are registered in an issue database. A notification of the registered issue is communicated via a messaging service of the computer system to an entity account associated with the entity. An information request is communicated from the entity account to the end-user account via the messaging service for private information at least indirectly identifying an end-user associated with the end-user account. The issue is flagged as unverified in the issue database if the private information is withheld by the end-user.

### CROSS-REFERENCE TO RELATED APPLICATIONS

This application claims the benefit of U.S. Provisional Application No. 62/375,027, filed on Aug. 15, 2016, and U.S. Provisional Application No. 62/475,447, filed on Mar. 23, 2017, the contents of both of which are incorporated herein by reference in their entirety.

### TECHNICAL FIELD

The following relates generally to online evaluation systems. In particular, the following relates to a method and system for determining metrics.

### SUMMARY

In one aspect, there is provided a method for determining metrics, comprising registering, in an issue database of a computer system, an issue associated with an entity and received from an end-user account via the computer system, communicating, via a messaging service, a notification of the registered issue to an entity account associated with the entity, communicating, by the computer system, an information request from the entity account to the end-user account via the messaging service for private information at least indirectly identifying an end-user associated with the end-user account, and flagging the issue as unverified in the issue database if the private information is withheld by the end-user.

The method can further comprise omitting the issue from a score calculated for the entity if it is unverified, and presenting, via the web interface, the score for the entity.

The method can further comprise including the issue for which an information request is unregistered in a score calculated for the entity, and presenting, via the web interface, the score for the entity.

The flagging can comprise flagging the issue as unverified following a set period of time after the communicating of the information request.

The flagging can further comprise flagging the issue as verified if the private information is provided by the end-user after the set period.

The private information can comprise one of an email address, a full name, a city of residence, a state of residence, and a telephone number.

The private information can comprise contact information. The contact information can comprise one of an entity account number and a reference number for a transaction between the end-user and the entity.

The information request can be presented to the end-user logged into the end-user account with at least one control for authorizing the entity account to access the private information if the private information has been registered by the computer system.

The at least one control can enable the end-user to authorize the entity account to access a subset of the private information.

The method can further comprise presenting a private information input interface to the end-user enabling entry and registration of the private information. The presenting can comprise presenting the private information input interface after registration of the information request if the private information is yet unregistered by the computer system.

In another aspect, there is provided a method for determining metrics, comprising registering, in an issue database of a computer system, an issue and an entity associated with the issue received from an end-user account associated with an end-user, communicating, via a messaging service provided through the computer system, a notification of the registered issue to an entity account associated with the entity, registering, by the computer system, a resolution offer indicator received from the entity account indicating that a resolution offer for the issue has been made to the end-user, presenting a user interface to the end-user using the end-user account for receiving a score for the resolution offer, registering the received score in the issue database, and presenting an aggregate score for the entity calculated as a function of the score for the resolution offer.

The method can further comprise registering, in the issue database, a subsequent resolution offer indicator received from the entity account indicating that a subsequent resolution offer for the issue has been made to the end-user, presenting the user interface to the end-user using the end-user account for receiving a subsequent resolution offer score for the subsequent resolution offer, registering the subsequent resolution offer score in the issue database, and presenting the aggregate score for the entity calculated as a function of the score for the subsequent resolution offer.

The registering of the resolution offer indicator can comprise receiving, via the messaging service, a message and the resolution offer indicator from the entity account.

The message can be for delivery to the end-user via the messaging service.

The message can be posted publicly.

The presenting the user interface can comprise presenting the user interface to the end-user using the end-user account upon login.

The presenting the user interface can further comprise prohibiting further interaction by the end-user with the computer system until the score is received.

The presenting the user interface can comprise presenting the resolution offered by the entity via the entity account.

According to a further aspect, there is provided a computer system for determining metrics, comprising a processor, and a storage storing an issue database, an account database, and computer-readable instructions that, when executed by the processor, cause the processor to register, in the issue database, an issue associated with an entity and received from an end-user account via the computer system, communicate, via a messaging service, a notification of the registered issue to an entity account associated with the entity, communicate an information request from the entity account to the end-user account via the messaging service for private information at least indirectly identifying an end-user associated with the end-user account, and flagging the issue as unverified in the issue database if the private information is withheld by the end-user.

According to yet another aspect, there is provided a method for determining metrics, comprising receiving, via a computer system, an electronic address for each of at least one person, transmitting, via the computer system, a feedback request to the electronic address for each end-user, and, for each end-user from which feedback is received via the electronic address, generating, via the computer system, an end-user account and associating the electronic address of the end-user therewith.

These and other aspects are contemplated and described herein. It will be appreciated that the foregoing summary sets out representative aspects of a computer system to assist skilled readers in understanding the following detailed description.

### BRIEF DESCRIPTION OF THE DRAWINGS

A greater understanding of the embodiments will be had with reference to the Figures, in which:

FIG. 1 shows a computer system for determining metrics and its operating environment in accordance with one embodiment thereof;

FIG. 2 is a schematic diagram showing various physical and logical components of the computer system for determining metrics of FIG. 1;

FIG. 3 is a flowchart of the general method of creating an end-user account on the computer system of FIG. 2;

FIGS. 4A and 4B is a flowchart of the general method of determining metrics with the computer system of FIG. 2;

FIG. 5 illustrates a company dashboard generated by the computer system of FIG. 1 immediately after registration of an issue;

FIG. 6 shows a private message screen generated by the computer system of FIG. 1 for the company representative;

FIG. 7 shows the company dashboard of FIG. 5 after the company representative has messaged the end-user;

FIG. 8 shows an end-user information window generated by the computer system of FIG. 1;

FIG. 9 is a flowchart of the general method of the end-user providing access to their private information using the computer system of FIG. 1;

FIG. 10 shows the company dashboard of FIG. 5 after the company representative has provided a resolution response;

FIG. 11 shows a portion of an issue page generated by the computer system of FIG. 1 upon posting of a resolution response;

FIG. 12 shows a resolution offer score screen generated by the computer system of FIG. 1 that is presented to the end-user that submitted the issue upon receipt of a resolution offer;

FIG. 13 shows the resolution offer score screen of FIG. 12 upon scoring of the resolution offer by the end-user;

FIG. 14 shows the updated issue page of FIG. 11 upon receiving a resolution offer score from the end-user;

FIG. 15 illustrates a widget generated by the computer system of FIG. 1 that summarizes the metrics for a company;

FIG. 16 is a flowchart of the method of obtaining feedback and registering an end-user;

FIG. 17 shows a review request page used by a company representative to solicit feedback from customers that may not be registered end-users of the site operated by the computer system of FIG. 1;

FIG. 18 shows an email form template that is stored by the computer system of FIG. 1 and editable via a control on the review request page of FIG. 17;

FIG. 19 shows a pop-up window that is presented to the company representative if feedback has previously been solicited from a customer specified via the review request page of FIG. 17;

FIG. 20 shows the review request page of FIG. 17, wherein pending review requests are exposed;

FIG. 21 shows the review request page of FIG. 17, wherein answered review requests are exposed;

FIG. 22A shows a portion of an issue registration screen generated by a computer system in accordance with another embodiment;

FIG. 22B shows the portion of the issue registration screen of FIG. 22A wherein a pop-up control enables a user to provide information about the issue;

FIG. 22C shows the portion of the issue registration screen of FIG. 22A after entry of information about the issue;

FIG. 22D shows the portion of the issue registration screen of FIG. 22A after activation of a sign in button;

FIG. 22E shows the portion of the issue registration screen of FIG. 22A after user log in;

FIG. 22F shows the portion of the issue registration screen of FIG. 22A after activation of a sign up button showing a registration pop-up control; and

FIG. 22G shows the portion of the issue registration screen of FIG. 22A after registration of the user.

### DETAILED DESCRIPTION

For simplicity and clarity of illustration, where considered appropriate, reference numerals may be repeated among the Figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

Any module, unit, component, server, computer, terminal, engine or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Further, unless the context clearly indicates otherwise, any processor or controller set out herein may be implemented as a singular processor or as a plurality of processors. The plurality of processors may be arrayed or distributed, and any processing function referred to herein may be carried out by one or by a plurality of processors, even though a single processor may be exemplified. Any method, application or module herein described may be implemented using computer readable/executable instructions that may be stored or otherwise held by such computer readable media and executed by the one or more processors.

Generally, entities expend a significant portion of their operating budget on brand management and customer retention in order to protect their investments in products and/or services and credibility. Entities can be companies, corporations, professional service providers, associations, organizations, charities, government departments and ministries, etc. With so many entities choosing to exploit the Internet for its ease of access and market benefits, such as lower barriers of entry and high scalability, industries have become increasingly competitive. Traditional approaches to building and retaining a customer base, reputation, and credibility are generally less effective for online-based entities. Further, Internet consumers and other users are more likely to search the Internet for information about an entity's responsiveness, equity, and credibility. In addition, consumers often post issues that they have with a company's product or the company as a whole due to the ability to do so with some expectation of privacy, but this is accompanied by virtually no expectation of resolution to the issue.

The term “issue”, as used herein, includes a complaint, misinformation, a review, and other comment.

This has led to a recent emphasis on customer support and strong public relations, which focuses primarily on customer dispute resolution, but this generally occurs only when the customer directly contacts the company. To deal with large numbers of disputes, customer support has been outsourced to countries where labour costs are low and the workers are instructed to follow certain guidelines to process resolutions.

Recently, an emphasis on human-assisted automated response has been used in the field of dispute resolution. Credit card companies use standard procedures for resolving payment disputes and deploy a system to automatically compare an incoming complaint to previously filed complaints to come up with a consistent response system for a high volume of complaints. However, in many cases where no reasonably comparable precedent exists, or the complainant is dissatisfied with the proposed resolution, a representative of the entity must intervene to resolve the dispute. A problem with this system is that the complainant has no real bargaining power and cannot always obtain a fair settlement and the avenues for review are often expensive and limited. Further, the lack of transparency in such systems leaves customers uncertain as to the effectiveness of lodging a dispute.

Various review and online retail web sites enable users to comment on products, services, and the companies that provide them, but there's generally no validation of the issues being posted and thus their effect on the entity's reputation. Similarly, an entity's performance in resolving issues, if there is an ability to do so, is not readily measurable in a reliable manner.

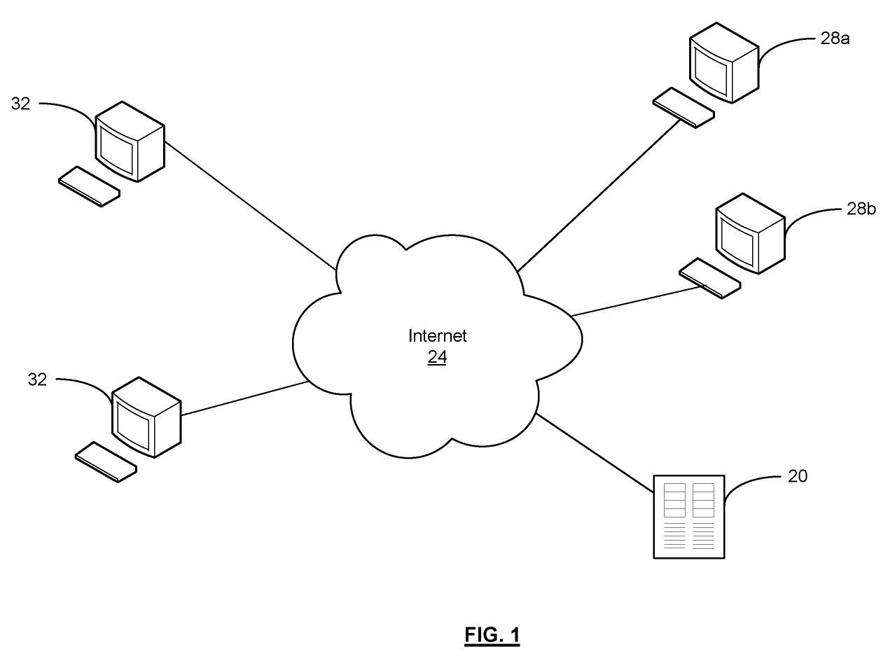

A computer system 20 for determining metrics in accordance with an embodiment is shown in FIG. 1. Computer system 20 operates a dispute resolution system that is accessible via a web interface. End-users can post an issue publicly on a website operated by computer system 20. As used herein, “end-user” means a person other than an entity representative or administrator that uses computer system 20. Each published issue identifies an entity associated with the issue. In the particular embodiment, computer system 20 enables end-users to register issues associated with businesses such as corporations, professional organizations, sole professionals, etc. (hereinafter, collectively referred to as “companies”). It will be understood, however, that computer system 20 can handle issues for other types of entities such as governments, charities or associations. Companies can engage end-users that have posted issues and attempt to resolve the issue, and can be assessed on the number of issues posted, the company's responsiveness to posted issues, and end-user satisfaction with any resolution they are offered. As posted issues can impact a company's reputation, it is desirable to identify posted issues that are, in fact, illegitimate. Issues may be posted illegitimately to damage to reputation of a company, to harass the company, etc. Computer system 20 allows issues posted by end-users that are unresponsive to one or more attempts to contact them to be flagged as unverified. Such issue posts can be publicly flagged as unverified, or removed from public presentation. Further, published metrics for a company can be adjusted in view of the possible illegitimacy of the issue and more likely reflect the entity's true performance in a reliable manner.

Computer system 20 is coupled to a computer network, which can be a public or private network. In the illustrated embodiment, the computer network is the Internet 24. A first company computing device 28a is operated by a representative of a first company. A second company computing device 28b is operated by a representative of a second company. Both company computing devices 28a, 28b are coupled to Internet 24. Additionally, a pair of end-user computing devices 32 is shown coupled to Internet 24. First company computing device 28a, second company computing device 28b, and end-user computing devices 32 are shown as desktop computers, but can be any computing devices that can communicate over Internet 24, such as laptop computers, tablet computers, smartphones, smart televisions, etc. Each of first company computing device 28a, second company computing device 28b, and end-user computing devices 32 executes a web application such as a web browser for interacting with computer system 20.

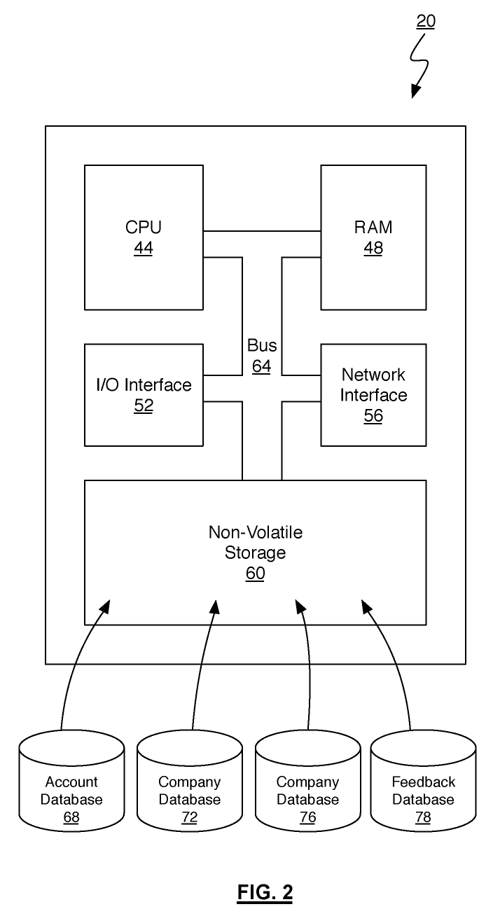

FIG. 2 shows various physical elements of computer system 20. As shown, computer system 20 has a number of physical and logical components, including a central processing unit (“CPU”) 44, random access memory (“RAM”) 48, an input/output (“I/O”) interface 52, a network interface 56, non-volatile storage 60, and a local bus 64 enabling CPU 44 to communicate with the other components. CPU 44 executes at least an operating system, a web server, a messaging service, and a database system. RAM 48 provides relatively responsive volatile storage to CPU 44. I/O interface 52 allows for input to be received from one or more devices, such as a keyboard, a mouse, etc., and outputs information to output devices, such as a display and/or speakers. Network interface 56 permits communication with other computing devices over computer networks such as Internet 24. Non-volatile storage 60 stores the operating system and programs, including computer-executable instructions for implementing the web server that provides the web interface, the messaging service, and the database system, the web server's data including files and scripts for generating web pages, messaging data managed by the messaging service, and a set of databases managed by the database system. During operation of computer system 20, the operating system, the programs and the data may be retrieved from non-volatile storage 60 and placed in RAM 48 to facilitate execution.

The web server executed by computer system 20 generates webpages that can be at least partially populated by dynamic content. The dynamic content is generated from data retrieved from an account database 68, a company database 72, an issue database 76, and a feedback database 78 via the database system. Controls in the web pages also enable data provided to be entered into user database 68, issue database 76, and feedback database 78.

Account database 68 stores login credentials and other account information for end-users and company representatives, such as an email address at which a user may be contacted. If a user is a company representative, a company and location(s) with which the representative is associated is also stored in account database 68. Company database 72 stores information about companies, their locations, their representatives for each location, and metrics for each company. The metrics include an issue count, a contact history, and a resolution rating. Issue database 76 stores data for each issue, including end-user provided information characterizing the issue and various statuses, comments from other end-users or representatives, indicators of support or lack of support with the end-user's issue, polls issued by the end-user or other end-users, and metrics for the issue. These include an issue status and a resolution score. Feedback database 78 stores feedback data for which no particular resolution may necessarily be sought. The feedback data can include, for example, reviews, feature suggestions, service suggestions, etc.

Account database 68, company database 72, issue database 76, and feedback database 78 can be separate databases, separate sets of tables in a single database managed by the database manager, etc.

The messaging service enables end-user accounts, company accounts, and administrator accounts to privately message each other, to publicly message via posting on the web interface, and communicates messages and notifications via external email.

Web pages generated by computer system 20 enable end-users to create accounts and subsequently register issues relating to the products and/or services of companies, or the companies themselves. Issues can include, for example, complaints about a product and/or service, a notification of unreceived products, parts, and/or services, software bugs, or other general or specific negative feedback. The company to which the issue applies is determined, and a notification is sent to a representative of the company. The representative can then log into computer system 20 using their account that is associated with the company, and message the end-user that registered the issue via the messaging service to attempt to resolve the issue. Computer system 20 tracks the responsiveness of the end-users to determine which issues may, in fact, are spuriously registered. Computer system 20 also registers when resolution offers have been made by company representatives and provides a user interface to permit end-users to whom resolutions were offered to score their level of satisfaction. Metrics for companies are determined by computer system 20 based on responsiveness to registered issues and scores for how satisfactory their resolution offers are.

Issues and their resolution status, as well as metrics for companies, are viewable via computer system 20 without logging into an account. In order for end-users to register an issue via computer system 20, however, they must first create an end-user account and log in.

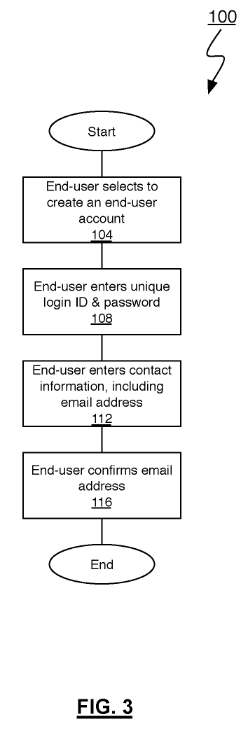

The method 100 of creating an end-user account via computer system 20 will now be discussed with reference to FIGS. 1 and 3. Method 100 commences with an end-user selecting to create an end-user account (104). The end-user opens and directs a web application, such as a web browser, on end-user device 32 to computer system 20, such as by clicking on a link or by entering the uniform resource locator (“URL”) of a web page served by computer system 20. Upon retrieving the specified web page from computer system 20, a link on the web page causes the web application on end-user computing device 32 to present an account creation screen. The end-user then selects and enters a unique login ID and a password (108). If the end-user wishes to have a username that differs from their login ID appear beside posts or in messages, the end-user can also enter the username at this time. Upon confirming that the login ID entered by the end-user is unique, computer system 20 creates an end-user account for the end-user. Next, computer system 20 causes end-user computing device 32 to present a private information input interface in the form of a screen on end-user computing device 32 in which the end-user can enter private information, namely contact information including a full name, a telephone number, a city of residence, a state of residence, and an email address at which he or she wishes to receive notifications (112). Private information is any information that the end-user provides that is not posted publicly on the site. The contact information can be used to contact the user. Contact information is any information that can be used to directly or indirectly contact a user. Other types of contact information can include, but are not limited to, a social media profile name (such as @surname for a Twitter account), a site or service user name, a messaging client account name, etc.

Only entry of an email address is mandatory at this time, as email notifications are sent by computer system 20 to the end-user at the provided email address when a message is received via the messaging service or when another notification is to be communicated to the end-user. The end-user's full name, telephone number, city of residence, state of residence, and email address are stored in the account database together with the login ID. The end-user then confirms the email address (116). After entry of the email address at 112, computer system 20 generates and sends an email to the email address specified by the end-user with an activation hyperlink in the body. Upon activating the hyperlink, computer system 20 registers confirmation of the email address and creates a corresponding account in account database 68, after which method 100 of creating an end-user account is complete.

Once the end-user account has been created, the end-user may register an issue at any time thereafter.

The general method 200 of determining metrics for a company will now be discussed with reference to FIGS. 1, 3, 4A, and 4B. Metrics are determined during the course of registering and resolving issues.

Method 200 commences with the posting of an issue by an end-user (204). In order to register an issue, end-user logs into computer system 20 using the login ID and password selected during method 100 above. After logging in and activating a control to register a new issue, the end-user is presented with a first issue registration screen enabling the end-user to enter a title and text for the issue. Alternatively, an end-user person can create an issue and then be asked to log in or create an end-user account once a button to register the issue is activated. This information will be posted publicly for the issue, along with the end-user-defined username. Upon completion of the first issue registration screen, the end-user is presented with a second issue registration screen in which information can be entered that will not be published to the public web. In particular, the second issue registration screen includes a company account number field, a company reference number field, and another private information field. This additional private information may be optionally completed and is not posted publicly with the issue on the website, but is instead stored and transmitted to the company representative to facilitate issue resolution. The additional private information can include, for example, reference information for a transaction, like an invoice number, an airline PNR, or a loyalty card number. It can help solve an issue and may or may not directly or indirectly identify the end-user who is registering the issue. The second issue registration screen clearly notifies the end-user that the additional private information will be sent to the company representative to facilitate issue resolution. The second issue registration screen also permits the end-user to identify the company by entering a company name and area (city, state/province, and country). The user may opt to enter some or all of the requested area information.

Using the information entered by the end-user on the second issue registration screen, computer system 20 searches company database 72 and an external business database using the company name and area provided by the end-user in the second issue registration screen. If the company name and area match one or more companies in company database 72 or the external business database, the end-user is presented with a list of entries from company database 72 that match the end-user's inputs. It is noted that there may be more than one company entry in company database 72 that matches the end-user entered company name and area, if one was specified, and that a single company may have more than one location (such as branches, retail stores, offices, etc.) within an area registered in company database 72. The end-user can then select an entry from the list, or may indicate that none of the entries match the company and location they intended to specify. In that case, or if an entry was not found in company database 72 corresponding to the end-user's entries, the entries identifying the company are accepted as is for the moment.

Upon completion of the first issue registration screen and at least the company information on the second issue registration screen, computer system 20 checks to ensure that all requisite information is collected and the end-user is presented with the information entered and asked to confirm it.

Computer system 20 then presents the end-user with a third issue registration screen that allows the end-user to submit images or documents, has the end-user describe the category of issue (e.g., poor service, poor product, pricing, warranty, etc.) and has the end-user describe the rectification that is requested (e.g., refund, apology, return, policy change, etc.). Upon confirmation after the third issue registration screen, computer system 20 determines if the end-user is logged in. If the user is not logged in, the end-user is requested to register, if not yet done, and log in to register the issue. Upon logging in by the end-user, the issue and the associated company are registered in issue database 76 and posted on one or more web pages generated by computer system 20.

Once the issue is registered and posted, the issue count for the company is incremented by one (206). An issue status field for the issue is then marked by computer system 20 as “awaiting response” in issue database 76 (208). In addition, a contact value is set to zero for the issue, denoting that the company has yet to contact the end-user regarding this issue.

The company representative for the company location that was specified in the second issue registration screen is then identified (212). Where the company (and location) was selected from the list presented during the registration of the issue at 204 by the end-user, the company representative for the selected location is retrieved from company database 72 should such representative already be identified. If, instead, the end-user specified a company and location not found in company database 72 or the external business database, the end-user enters the information known manually and an administrator verifies the company name and location, as well as a representative for the company's location, registers them in company database 72, and associates it with the registered issue in issue database 76. Further, the moderator sends the identified company representative an invitation to register as the representative for the company at the specified location, or, alternatively, the moderator can take the action to register the representative.

Computer system 20 then alerts a moderator of the registered issue if a manual company location was entered by an end-user or a representative is not yet registered to the company (216). A moderator is a person having administrative access to computer system 20 for the purpose of facilitating resolution of issues.

The company representative is then notified of the registered issue (220). Computer system 20 sends, via the messaging service, an email to the email address of the representative in company database 72 associated with the registered issue to invite them to resolve the issue. The email contains a link to the issue on the web if the company has not claimed their profile page in the system, or to their company dashboard on the web interface operated by computer system 20 where registered issues for a company may be viewed, if the company has claimed their profile page in the system.

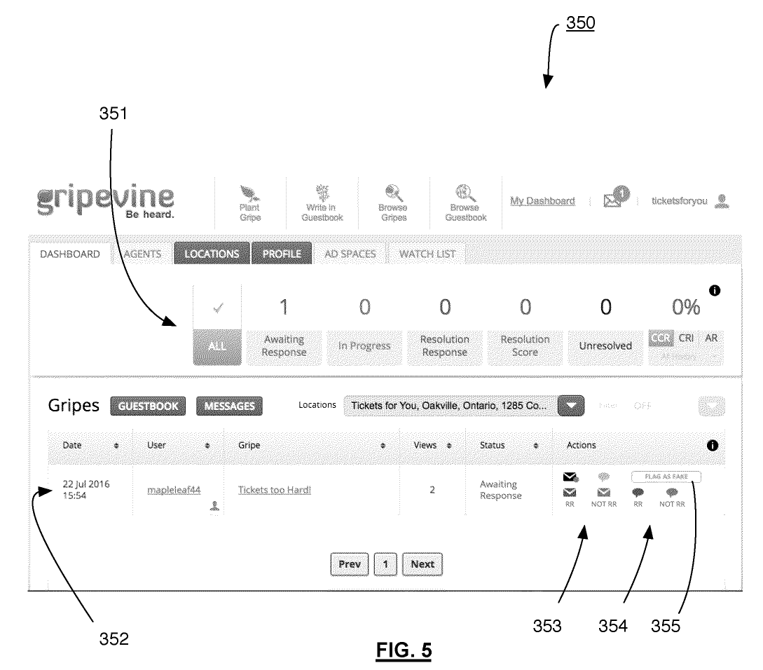

FIG. 5 shows an exemplary company dashboard 350 generated by computer system 20 providing a notification that an issue has been registered for the company. Company dashboard 350 provides an issue status summary 351 for the company, including the number of issues awaiting a response from the company, the number of issues in progress, the number of resolution responses (offers) sent, the number of resolution scores received, the number of unresolved issues, the customer contact rate, the customer resolution index, and the average rating score received from the review portion of the system. As shown, the company has a single issue awaiting response. Additionally, company dashboard 350 presents a list of pending issues 352 managed by computer system 20. For each registered issue, a set of private messaging controls 353, a set of public messaging controls 354, and a flag-as-fake control 355 are shown. Private messaging controls 353 enable a company representative to directly message, via the messaging service, the end-user that registered the issue. Public messaging controls 354 enable the company representative to post a public message via the messaging service on an issue page where the registered issue is publicly viewable. Flag-as-fake control 355 enables the company representative to identify an issue as being unverified, but is not activatable at this time as the company has not yet responded to the issue.

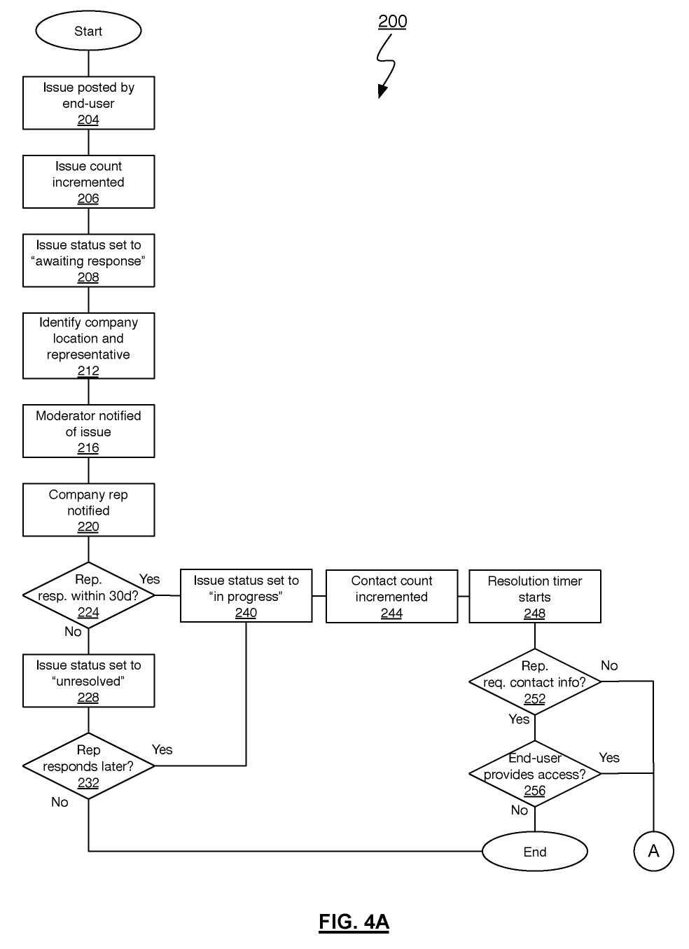

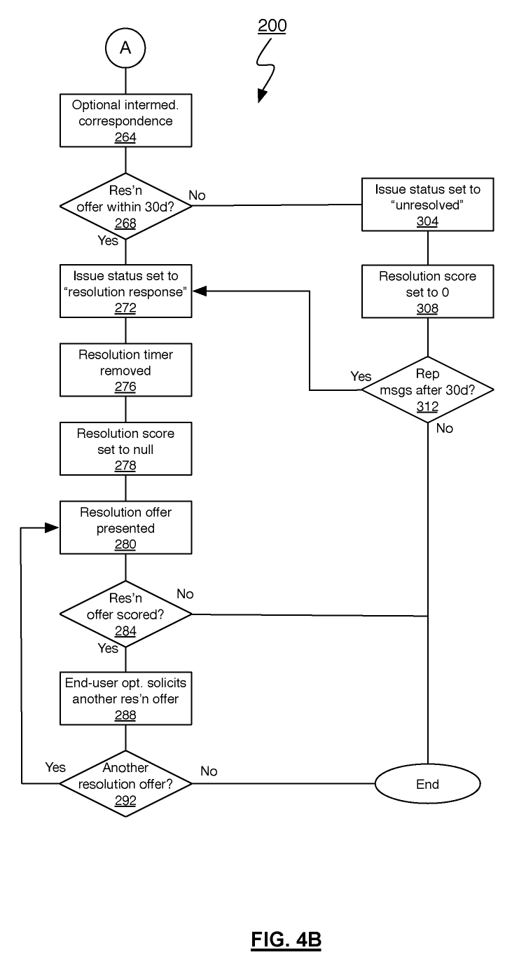

Returning again to FIGS. 4A and 4B, computer system 20 then determines if the company representative responds to the end-user on the issue within 30 days (224). The representative can respond by activating one of private messaging controls 353 or public messaging controls 354 to respond either privately via a message directly sent to the user on the site or publicly on the issue page for the issue. Both of these activities trigger computer system 20 to send an alert email to the end-user at the email address that he or she specified.

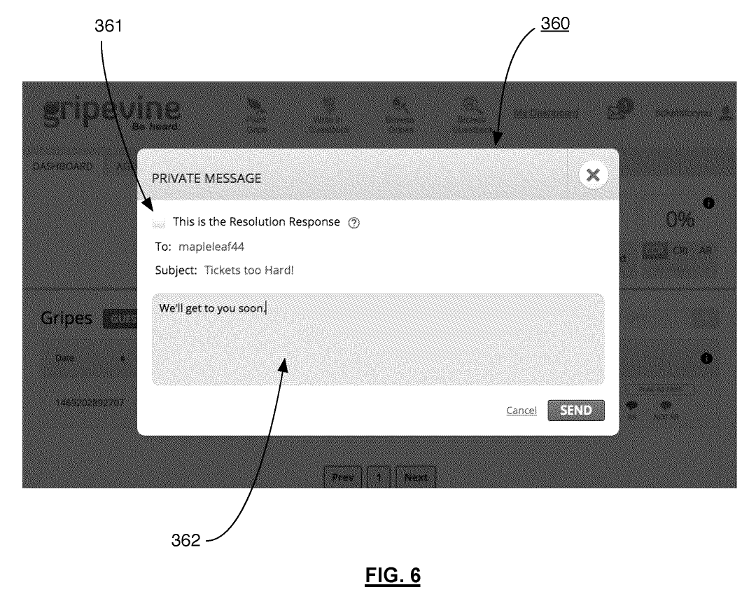

FIG. 6 shows a private message screen 360 generated by the computer system of FIG. 1 for the company representative to privately message the end-user that registered the issue. A resolution response checkbox 361 enables the company representative to indicate that the message represents a resolution offer. A message body box 362 enables the company representative to enter a message to be sent to the end-user.

Returning again to FIGS. 4A and 4B, if the company representative doesn't respond to a registered issue within 30 days, the issue status is set to “unresolved” in issue database 76 (228). Computer system 20 determines if the company representative responds later (232). If the company representative does respond at a later time, the method 200 ends.

If, instead, at 224 or at 232, it is determined that the company representative responds to the end-user, computer system 20 sets the issue status to “in progress” (240). Computer system 20 determines that the company representative has responded to the end-user that registered the issue by the sending of a private message to the end-user or by the posting of a message on the issue page by the company representative.

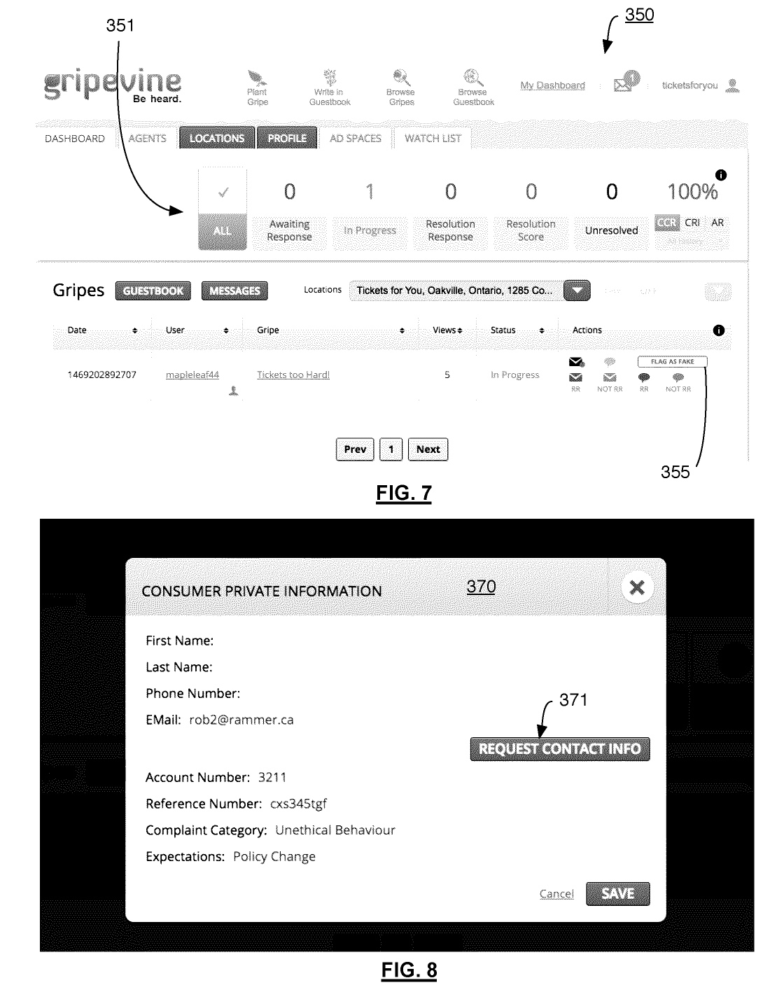

FIG. 7 shows company dashboard 350, wherein issue status summary 351 for the company has been updated to reflect the company representative's response to the end-user that registered the issue. In particular, there are no longer any issues awaiting response, and there is now one issue in progress. Flag-as-fake control 355 is activatable at this time as the end-user that registered the issue has been replied to.

Returning again to FIGS. 4A and 4B, the contact count for the company is then incremented by one (244). Next, a resolution timer is started (248). The resolution timer generates a metric that tracks how long it takes for an issue to be resolved once the company representative contacts the end-user.

After some or no intermediate correspondence, either publicly or privately on the site, the company representative can request access to some or all of the withheld private information of the end-user (252).

FIG. 8 shows an end-user information window 370 generated by computer system 20 for the company representative upon activating the head/shoulders icon next to the user name on the grid in FIG. 7) As shown, end-user information window 370 has blank fields for the end-user's first and last names, and for the user's telephone number. The end-user's email address registered by computer system 20 is, however, shown, as well as various details of the issue provided by the end-user, including the account number, the reference number, the complaint category, and an issue resolution expectation. By activating a request contact info control 371, a company representative can send a message to the end-user requesting that the end-user provide withheld private information. In this embodiment, the withheld private information is contact information provided by the end-user; that is, the user's first and last name, city of residence, state of residence, as well as their telephone number.

The request is sent via the messaging service to the end-user. If the end-user has previously entered in his or her contact information, the end-user is presented with a private information input interface with the stored contact information (enabling corrections to be made, if necessary) and a button in the message that may be activated to grant access to the contact information stored by computer system 20 to the company representative's account. Otherwise, the end-user is prompted to enter in their contact information into the private information input interface and activate a control (e.g., a button) to release the entered contact information to the company representative.

Returning again to FIGS. 4A and 4B, it is determined whether the end-user provides access to the private information in response to the request (256).

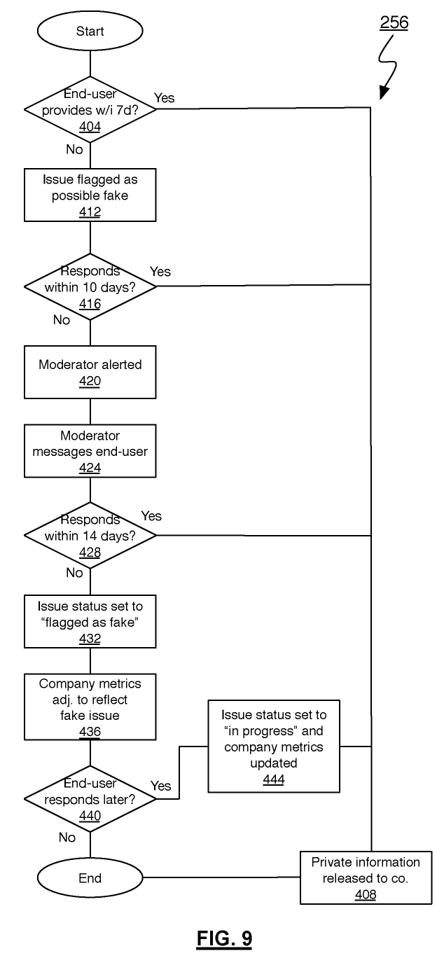

FIG. 9 shows the method 256 of determining whether the end-user provides access to their withheld private information. The method 256 begins with the determination of whether the end-user provides access to their withheld private information within seven days (404). The end-user has, during registration, entered and confirmed his or her email address. The end-user is notified via email by computer system 20 that the company representative has requested access to this information, and perhaps name and phone number, and can select whether to provide access to this information to the company representative. If the end-user selects to respond positively to the authorization request, either by providing the requested private information or by releasing access of previous-provided private information stored by computer system 20, access is granted to the company representative to the end-user's private information (408). A message is sent by computer system 20 to the company representative providing them with the private information or notifying them of their access to it via the web interface, and the resolution time is reset, after which the method 256 ends.

If, instead, the end-user does not respond positively within seven days at 404, computer system 20 flags the issue as potentially being fake (412). A flag is set on the issue identifying it as an issue for which private information was requested. Alternatively, computer system 20 can be configured to not automatically flag issues as fake and may rely instead on a company representative to do this via company dashboard 350 if the end-user has not responded. When the end-user does not provide access to their withheld private information, the end-user is deemed to be acting in bad faith and not desiring of a resolution to the issue. Computer system 20 then determines if the end-user responds within ten days of the private information request (416). If it is determined that the end-user has not responded with permission to communicate with them through private communication channels within ten days of the company representative requesting the end-user's private information, a moderator is alerted (420). The moderator messages the end-user via a site message that is then forwarded to the end-user via the email address provided upon registration (424). Computer system 20 then determines if the end-user responds within 14 days of the request for private information (428). If it is determined that the end-user has not responded within 14 days by providing access to the private information to the company to enable them to work towards a resolution, computer system 20 sets the issue status to “flagged as fake” (432). Flagging an issue as fake identifies the issue as unverified. Metrics for the company associated with the issue are then adjusted to remove the issue (436). Metrics for the company are determined by excluding issues deemed to be unverified. At this time, for the company, the issue count and the contact count are adjusted to disregard the unverified issue.

Computer system 20 then determines if the end-user responds later to the request for private information (440). If the end-user responds at a later time, the issue status is set to “in progress” and the company metrics adjusted at 436 are updated (444). That is, as the issue is deemed a confirmed issue, the issue count and contact count are both re-incremented by one. The end-user's private information is then released at 408. If, instead, the end-user does not respond thereafter to the request for the private information, the private information is not released by computer system 20 to the company representative and method 256 ends.

Returning again to FIGS. 4A and 4B, if it is determined at 256 that the end-user does not provide access to the private information, method 200 ends.

If, instead, it is determined at 252 that the company representative did not request private information or that the end-user has provided access to requested private information at 256, method 200 proceeds to 264, at which some optional intermediate correspondence may occur. The company representative can use the contact information provided by the end-user to communicate directly with the end-user, and/or the company representative and the end-user can communicate via public or private messages via computer system 20.

It is determined if the company representative makes a resolution offer within thirty days of being given access to the end-user's private information (268). The company representative can flag any correspondence sent to the end-user via the messaging service of computer system 20 as a resolution offer. This can include private messages and public messages, such as posts. When the company representative selects to send a public or private message, a control enables them to flag the message as including a resolution offer. An example of a resolution offer could be, for example, a partial or full refund of the end-user's cost for a product or service, a credit for future products and/or services, free or discounted servicing of a product, etc. The company representative can offer a resolution based on the end-user's guidance provided in the third issue registration screen regarding the type of resolution that they desire. An exemplary mode of flagging a message as a resolution offer is the checking of resolution response checkbox 361 of private message screen 360 as illustrated in FIG. 6.

Upon registering the resolution offer, computer system 20 sets the issue status to “resolution response” (272).

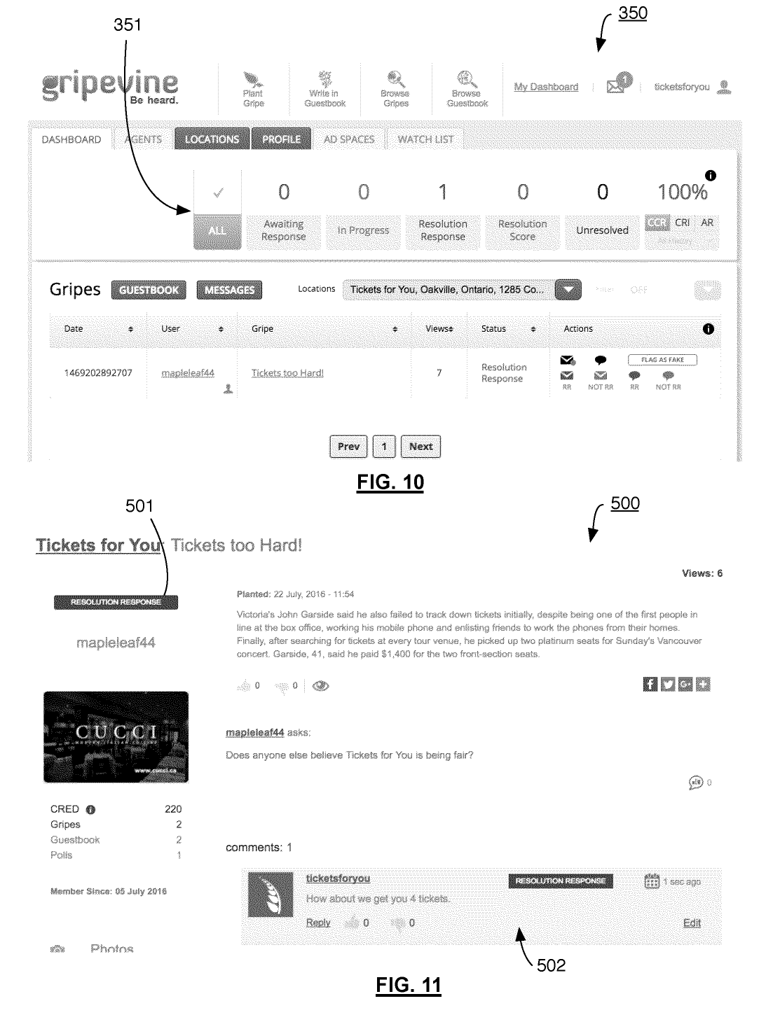

FIG. 10 shows the company dashboard 350 after registration of the resolution offer. Issue status summary 351 is updated to reflect the resolution offer.

FIG. 11 shows an issue page 500 generated by computer system 20 upon posting of a resolution response as a public message. An issue status indicator 501 indicates that a resolution offer has been made to the end-user. Further, a resolution response message 502 in the thread is identified via a shaded background.

Returning again to FIG. 4B, the resolution timer is then removed (276). Before removal, the resolution timer is tallied for the company in order to be able to calculate average time to resolution. Once the resolution offer is made by the company representative, the company representative is deemed to have completed a normal resolution cycle. The resolution score is initialized at null (278).

The registered resolution offer is then presented to the end-user and a score for the resolution offer is solicited from the end-user (280). The web interface operated by computer system 20 is configured such that when an end-user logs in, or at the time a resolution offer is received if the end-user is logged in then, he or she is presented with any unscored resolution offers.

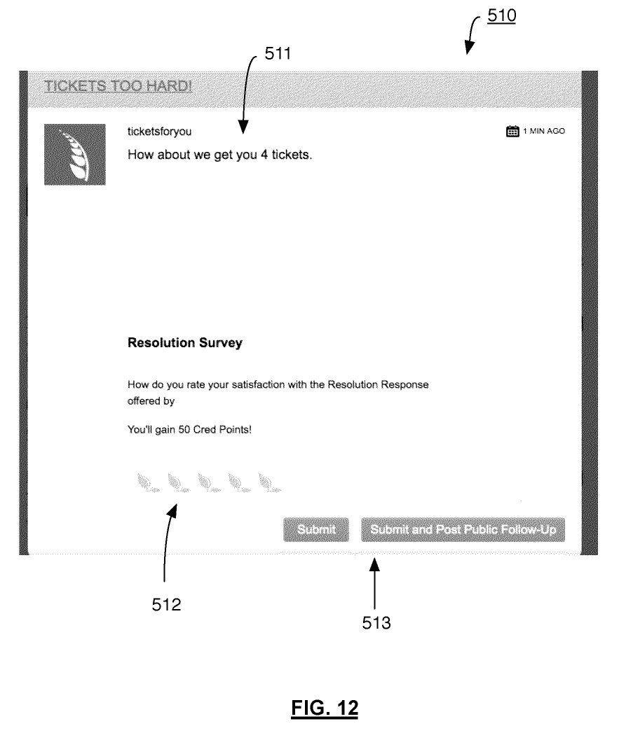

FIG. 12 shows a resolution offer window 510 that is presented to the end-user that received the resolution offer shown in FIG. 11. Resolution offer window 510 presents a single resolution offer that must be scored prior to further interaction with the web interface. A resolution offer message 511 in resolution offer window 510 conveys the resolution offer. The end-user can then score the resolution offer via a scoring control 512. The scoring control 512 enables the end-user to evaluate the resolution offer. In the current implementation, the resolution offer can be scored using the following scores: 1 for far below expectations; 2 for below expectations; 3 for meets expectations; 4 for above expectations; and 5 for far above expectations. Other discrete and continuous scoring schemes can alternatively be used. The resolution score is registered to be able to determine an average resolution score for the company. A submit button set 513 is greyed out, indicating that it is unactivatable at this time since a resolution offer score has not yet been entered by the end-user. As a result, resolution offer window 510 cannot be passed by the end-user until a resolution offer score is received.

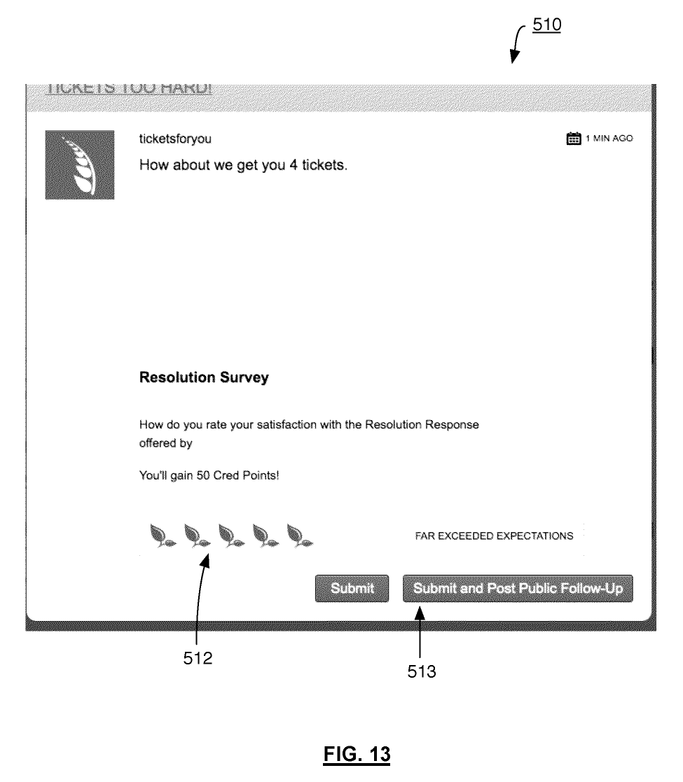

FIG. 13 shows resolution offer window 510 after scoring of the resolution offer by the end-user. As can be seen, scoring control 512 shows that the end-user has rated the resolution offer as 5 out of 5. Submit button set 513 is now activatable after receiving the scoring from the end-user, thus enabling the end-user to view other pages, screens, etc. generated by computer system 20.

Computer system 20 then determines if the resolution offer is scored by the end-user (284). The resolution score entered by the end-user replaces the current resolution score registered by computer system 20 for the issue.

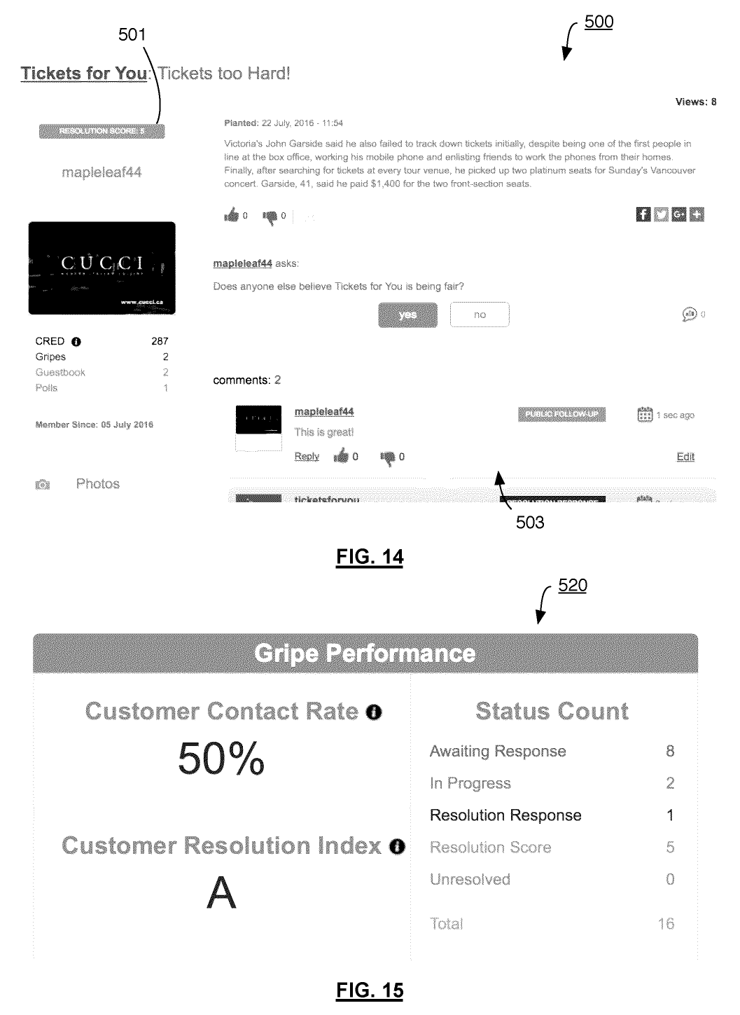

FIG. 14 shows issue page 500 upon receiving a resolution offer score from the end-user. Issue status indicator 501 indicates the resolution offer score received from the end-user. Further, a public follow-up message 503 in the thread is generated as a result of the end-user having selected to post a follow-up message via a corresponding one of submit button set 513 and entered text for the message.

Returning again to FIG. 4B, if the resolution offer is scored by the end-user, it may be possible that the end-user invites the company representative to make another resolution offer (288). The end-user may have a different resolution in mind, or may simply express dissatisfaction with the resolution offer to the company representative. The company representative may deem it appropriate to make another resolution offer, such as by publicly posting, privately messaging, or simply by the poor scoring of the resolution offer by the end-user at 284.

If it is determined that the company representative makes another resolution offer (292), the method 200 returns to 280, where the resolution offer is presented to the end-user. If, instead, it is determined at 292 that no other resolution offer is made by the company representative, the method 200 ends.

If, instead, it is determined at 284 that the end-user does not score the resolution offered by the company representative, the resolution score remains at null, or a previously-entered resolution offer score for the issue if one has already been received at 284, and the method 200 ends. A resolution offer score of null is not taken into consideration in determining an average resolution score, referred to as a “Customer Resolution Index” on the site, for the company.

If, instead, it is determined at 268 that the company representative does not message the end-user within 30 days, the issue status is set to “unresolved” (304). In addition, the resolution offer score for the issue is set to zero (308). This resolution score is used in the calculation of the average resolution offer score. It is then determined if the company representative contacts the end-user after the expiry of 30 days (312). If the company representative makes a resolution offer after 30 days by flagging a message as a resolution offer, method 200 proceeds to 272, at which computer system 20 sets the issue status to “resolution response” and scoring for the resolution offer is sought from the end-user. If, instead, computer system 20 determines that the company representative does not make a resolution offer at any time at 312, method 200 ends.

Computer system 20 continually tracks and updates the metrics for each company. In particular, for each company, the following are calculated and presented: number of issues, the average contact rate, the average resolution score, and the average rating from the review section of the system. These metrics are presented on the site.

FIG. 15 shows a widget 520 that is included in a company summary page. The user interface element 500 indicates aggregate scores, including a customer contact rate, a customer resolution index generated from the average resolution offer score, and the number of issues awaiting a response, in progress, for which a resolution has been offered and not yet scored, resolution scores received, unresolved, and the total.

The end-user can elect to delay remitting the private information, such as his or her full name and phone number to computer system 20 via the web service until after the creation of an end-user account and registration of an issue. This may be done, for example, after the receipt of a first private information request, after which the private information can be stored for future private information requests.

While in the above-described embodiment, private information is registered prior to registration of an issue, it may also be registered by the end-user at a later time. For example, computer system 20 may request the end-user to enter private information upon receipt of a request for the private information from a company representative. Upon registering the private information, it may be stored and used to satisfy future private information requests.

While the private information withheld in the above-described embodiment is the end-user's contact information, in other embodiments, it can be another subset or all of the end-user's private information.

It may be desirable for a company to reach out to a set of customers in a customer database in order to receive feedback on the company or a product or service. In addition, the company may wish to encourage their customers to provide feedback via a single site in a manner which allows the company to respond.

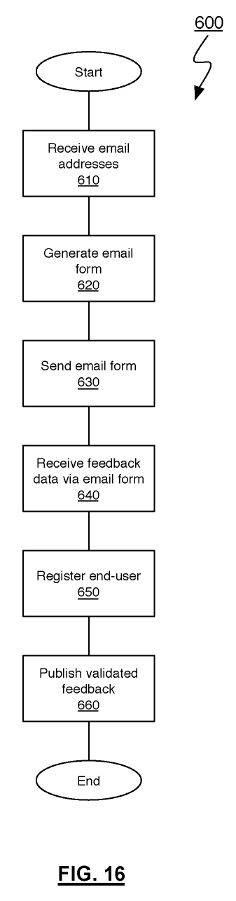

FIG. 16 shows a general method 600 of obtaining feedback and registering an end-user. The method 600 commences when one or more email addresses are received from a company representative (610).

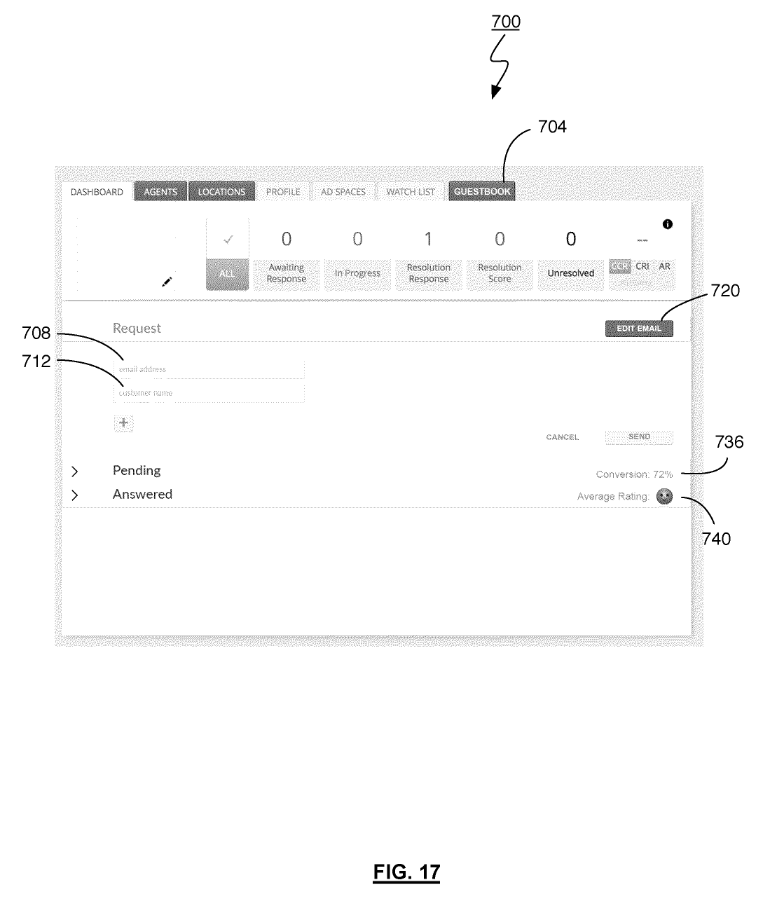

FIG. 17 shows a review request page 700 of the company dashboard used by a company representative to solicit feedback from customers that may not be registered end-users of the site operated by the computer system 20. The feedback solicited via the computer system 20 in this scenario relates to reviews, but, in other scenarios, could be other types of feedback, such as product feature requests, service feedback, feedback on proposed products and/or services, etc. The feedback data corresponding to this feedback is stored in the feedback database 78 of the computer system 20. The review request page 700 is accessed via a guestbook tab 604 that enables a company representative to easily solicit reviews on their products or services from a set of customers or other persons (hereinafter referred to as “customers”). The customers may or may not be registered end-users of the site operated by computer system 20. The review request page 700 enables the company representative to enter email addresses and names for customers of the company via an email address field 708 and a name field 712 respectively. While this embodiment is described with particular reference to email addresses, other types of electronic addresses can be employed, such as mobile phone numbers, uniform resource identifiers, site profile identifiers (e.g., http://www.socialmediasite.com/johndoe), service profile identifiers (@johndoe), etc.

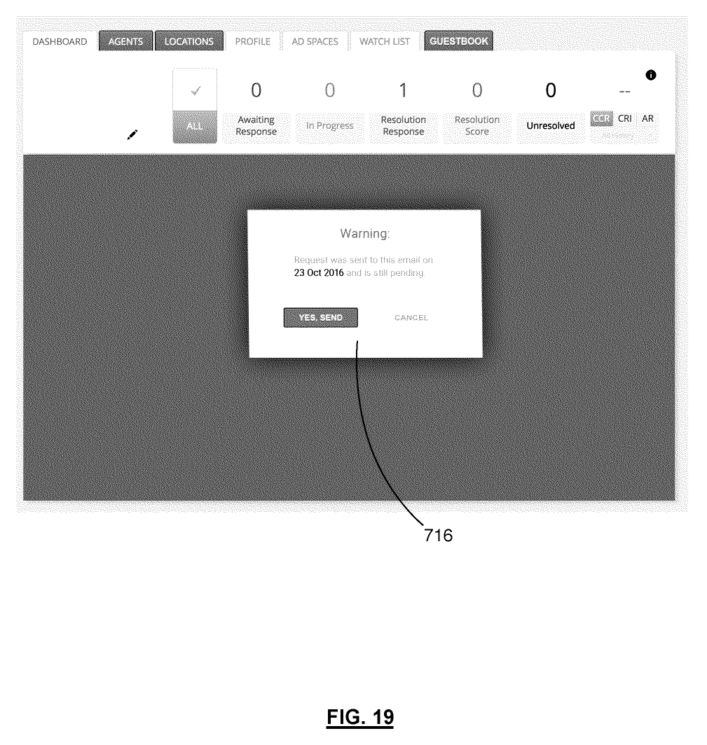

During the process of entering email addresses, computer system 20 checks for each email address provided if an email form was previously sent to the same email address. FIG. 19 shows a pop-up window 716 that is presented to the company representative if feedback has previously been solicited from a customer specified via the review request page 700; that is, if a review request for the specified email address is currently pending or has been provided.

As the email addresses are received from the company representative, computer system 20 generates end-user accounts for each email address, and flags them as unconfirmed.

Before, during, or after entering email addresses, an email form is generated (620). Referring again to FIG. 17, the company representative can generate and/or edit an email form that will be sent to the email addresses entered by activating an edit email control 720 to launch a rich email form editor for modifying an email form template.

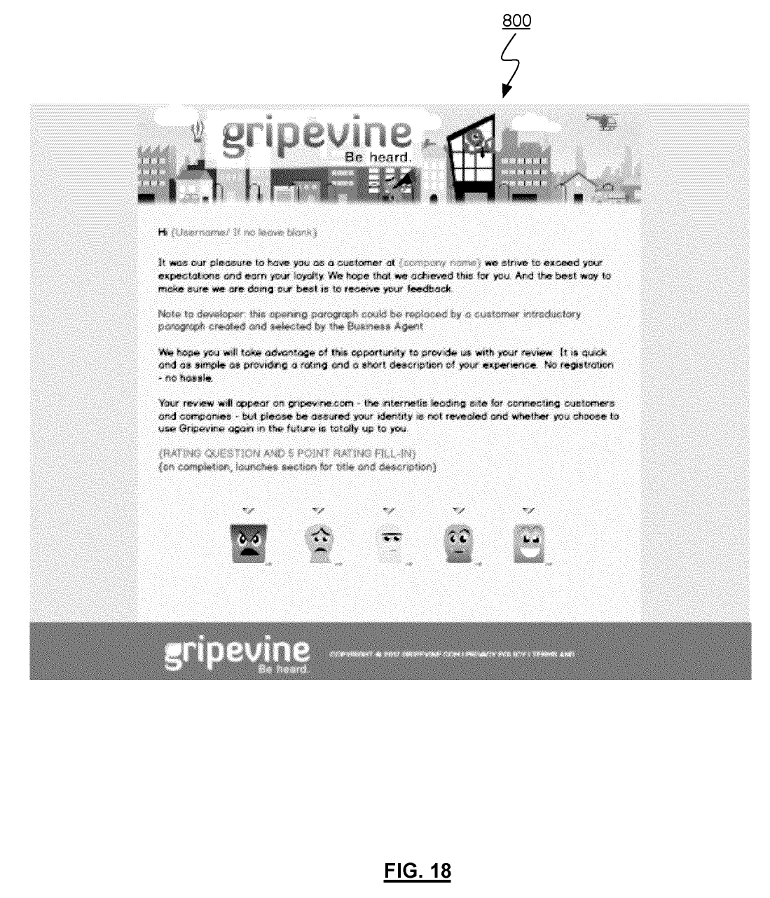

FIG. 18 shows an exemplary email form. A standard pre-set introduction or a customized introduction set by the company representative can be provided in the email form. The email form generated by computer system 20 enables customers to provide a review directly via the email form. The email contains five different emoji images relating to sentiments from “Very Unsatisfied” to “Very Satisfied”. In addition, each emoji image links via a uniform resource identifier (“URI”) in the form of a uniform resource locator (“URL”) to a page on the site run by computer system 20 with the review form. Each link contains a token corresponding to the “feeling” of the customer represented by the emoji. The email form also includes a link with a token for the customer to enable the recipient to indicate that they do not wish to receive emails of this type. Clicking on this link causes a request for a page to be generated by a web browser on the customer's computing device that computer system 20 receives, enabling computer system 20 to extract via the token the email address of the customer to which no further emails should be sent.

Upon receiving the email addresses and generating the email form, the email forms are sent (630). Once the company representative has entered the email addresses at 610 and generated an email form at 620, the company representative can approve for computer system 20 to send out email forms to the email addresses specified. Computer system 20 performs what is referred to commonly as a mail merge to insert each customer's name provided during 610 into the email form that he or she is sent.

Feedback data is then received from one or more of the customers (640). Upon receiving the email form, a customer can interact with it to provide feedback data. When a customer activates one of the five emoji images representing their feeling, a web browser or web-enabled application on the customer's computing device requests a page via the link including the token corresponding to the emoji/value that the customer chose.

Upon receiving the request for the linked page, computer system 20 determines if the token corresponds to one that was transmitted yet unused to ensure that the user requesting the page to complete a review has been identified by the company representative and has yet to submit a review. If the token doesn't match one that was previously generated and sent by computer system 20, the user is presented with a notification page, indicating that the requested page cannot be accessed at this time. Alternatively, the company representative can select an option to allow previously unspecified users to submit reviews, in which case a user is presented with a review page.

If, instead, the token matches an unused token generated by computer system 20, the link directs the web browser to a review page that includes fields for a customer-provided title, customer comments, and a submit control button. The customer then proceeds to complete the review process on the linked page.

By virtue of the customer's email address being provided by the company representative, and the customer's activation of the link including the token, the customer's email address is deemed confirmed and the end-user (i.e., the customer) is considered fully registered (650). A user name and a one-time password are generated on behalf of the end-user. The public facing user name is generated anonymously by computer system 20. For example, the user name assigned can follow a naming convention such as “GripesterXXX”, where the “XXX” is replaced with a sequence of random numbers. The one-time password is used simply as a placeholder by computer system 20. The review page served to the customer's computing device can direct the customer to change their password. As the end-user is confirmed and registered, the review data provided by the end-user is deemed validated and can be published as a validated review (660).

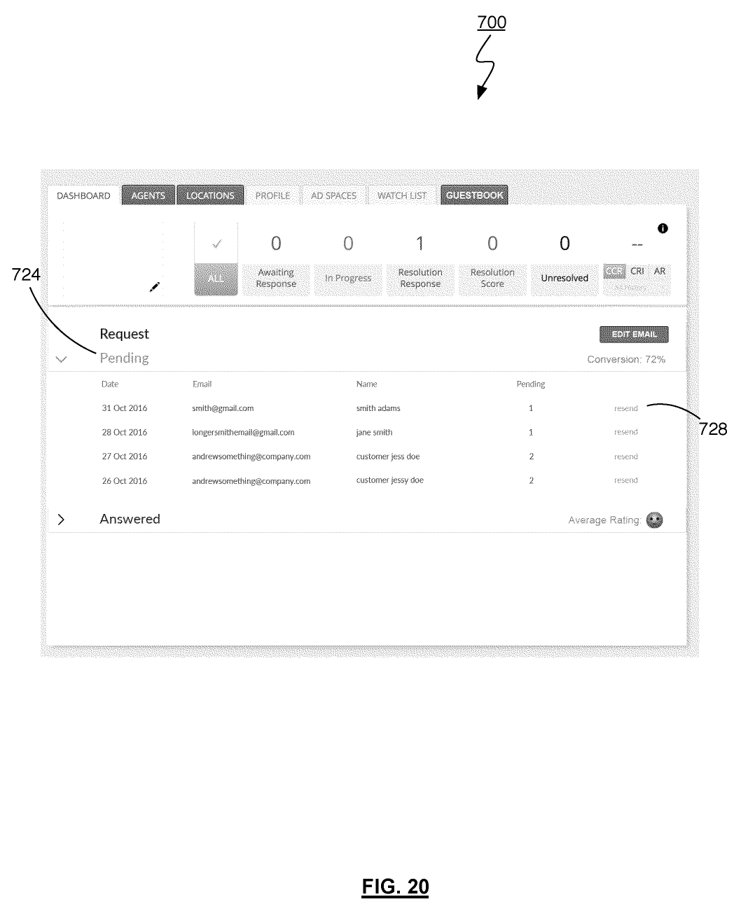

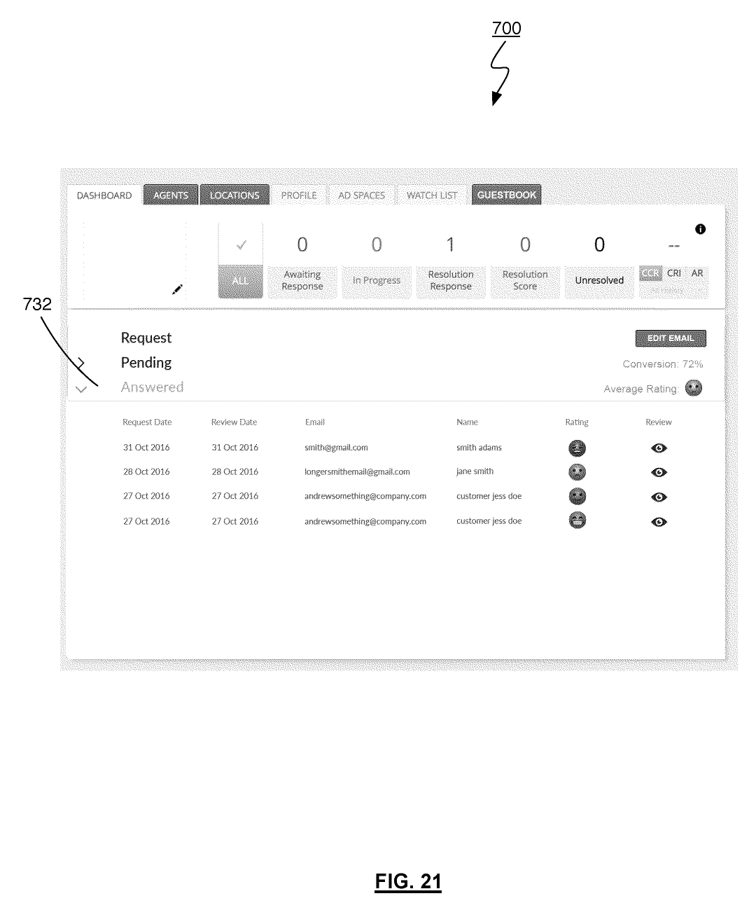

The company representative can view which reviews are pending or answered at any time after sending out email forms. FIG. 20 shows the review request page 700 after activation of a pending section title 724, wherein pending review requests are exposed. The pending review requests include the request date, the customer email address and name, and the number of requests sent to the customer. The company representative can review which customers have responded to the email form sent. Those that have not yet responded are presented as pending. The company representative can resend the pending review request to one or more of the identified customers that have yet to respond via a resend control 728.

Similarly, those that did respond are presented in a consolidated view along with their feedback data or a summary thereof. FIG. 21 shows the review request page 700, wherein answered review requests are exposed after activation of an answered section title 732. The answered review requests include the request date, the review date, the customer email address and name, and the rating submitted by the customer.

Referring again to FIG. 17, a conversion rate indicator 736 indicates the conversion rate on review requests sent, and an average rating indicator 740 provides a summary of the ratings received in response to the review requests sent out.

Using this approach, an end-user does not need to perform any setup administration work to accomplish the publishing of a validated review for the company. The new end-user may subsequently log in to the site operated by computer system 20 and modify their password and the username assigned to their profile by computer system 20.

In an alternative embodiment, issue registration can be commenced prior to the user registration process.

Prior to completion of the registration of the issue, if the user is not logged in, the computer system can prompt the user to log in or register in order to complete the issue registration. The user registration and private information provisioning process can in some cases take place via a link to a single sign on platform, such as Facebook, Google, or Twitter If the user is unregistered, the computer system can take the user through a user registration process such as that of method 100 above. Upon registering as a user, if previously unregistered, and logging in, computer system 20 may enable the issue registration to be completed.

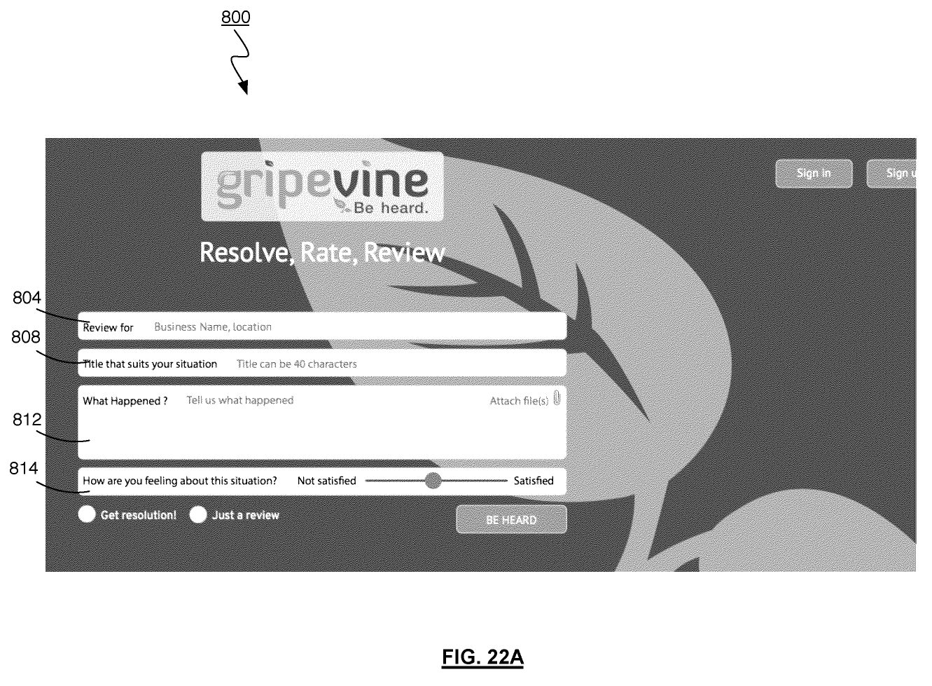

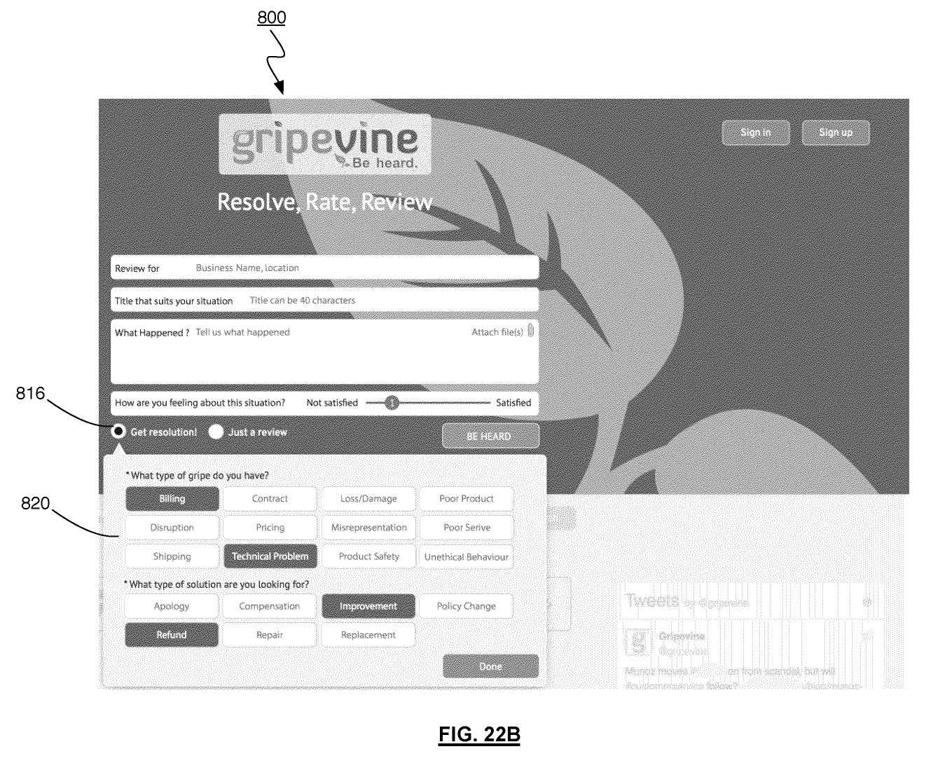

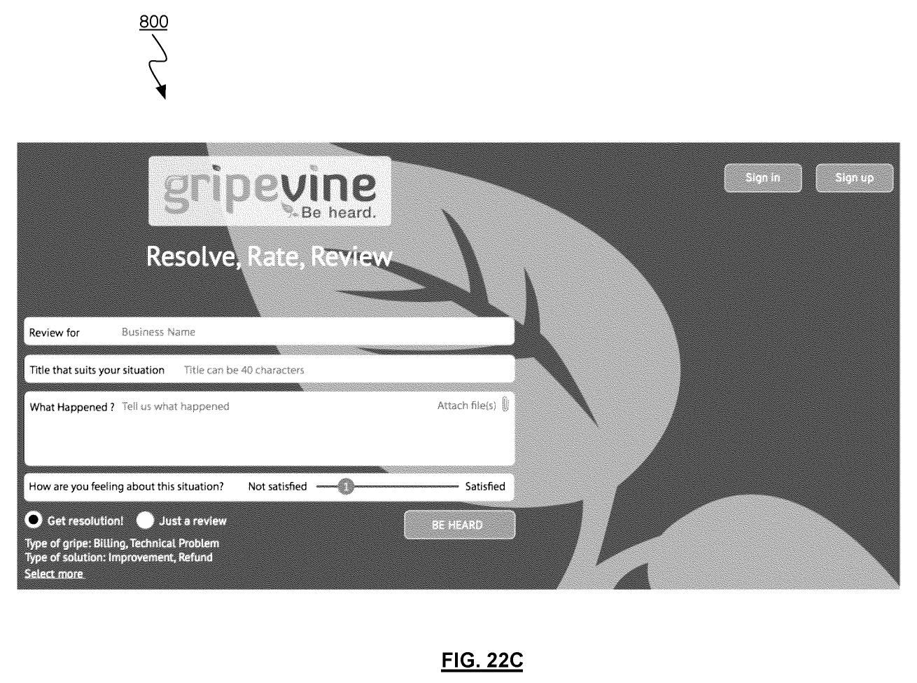

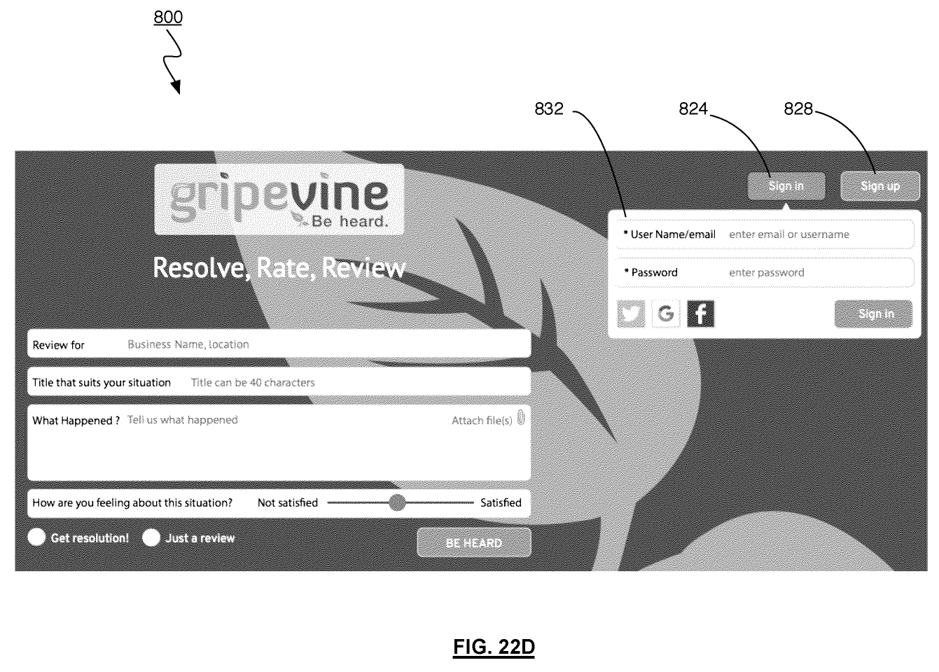

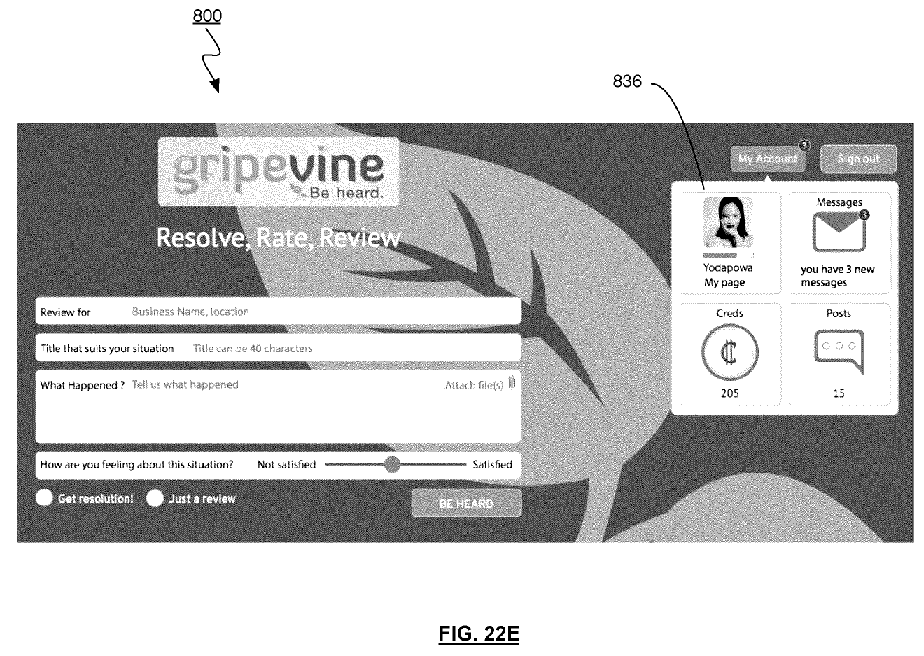

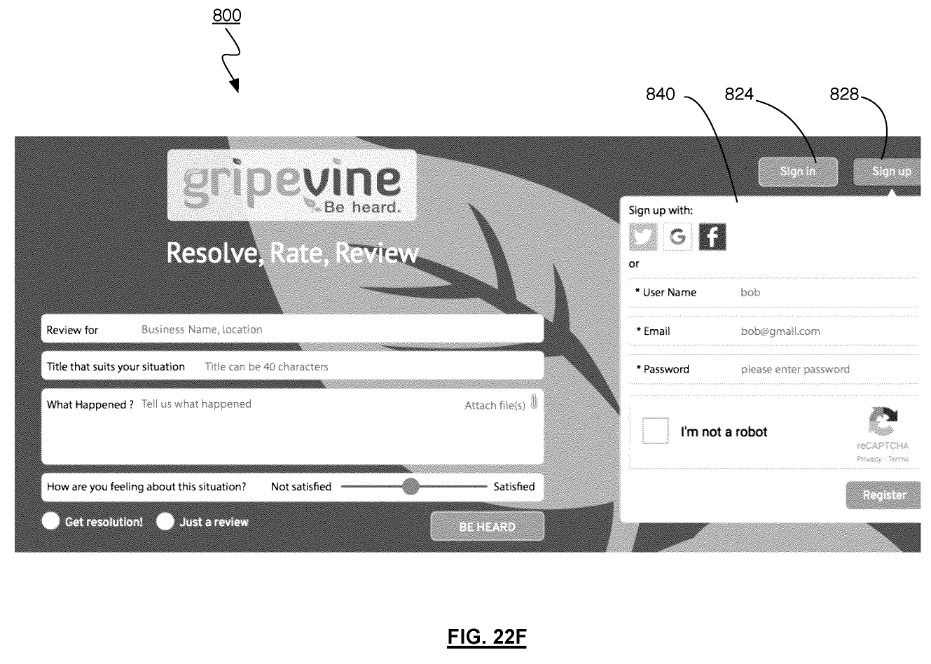

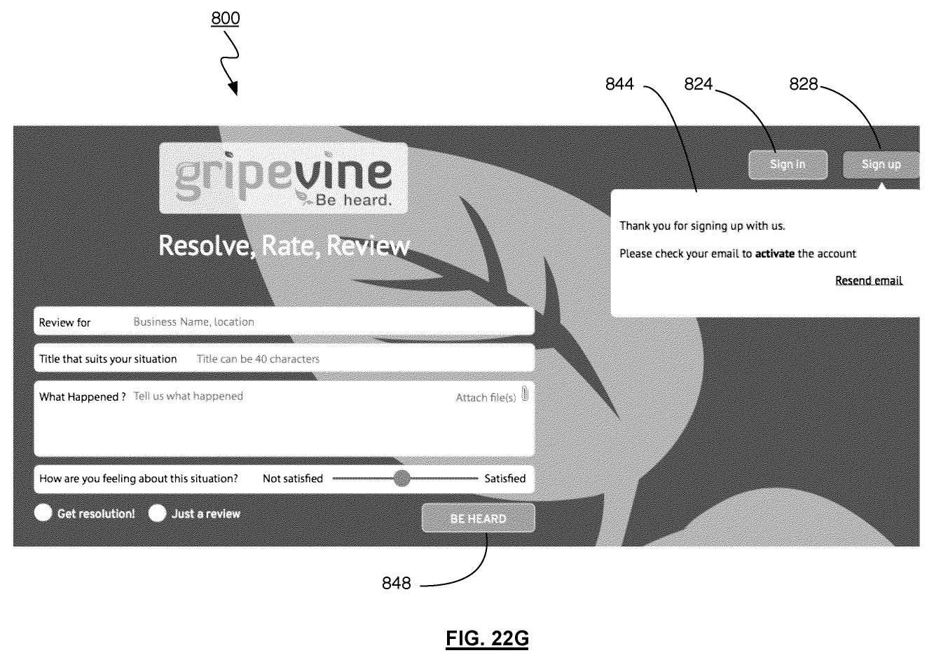

FIG. 22A shows a portion of an issue registration screen 800 generated by a computer system in accordance with this embodiment. The issue registration screen 800 has an entity name field 804 for entering in the name of the entity with which the issue is associated, an issue title field 808 for entering in a title for the issue, an issue description field 812 for entering a description of the issue, and an issue rating slider 814 for entering a rating for how the user feels about the issue.

FIG. 22B shows the portion of the issue registration screen 800 after activation of a resolution radio button 816, wherein an issue type pop-up control 820 enables a user to indicate the type of the issue. The user can select from “billing”, “contract”, “loss/damage”, “poor product”, “disruption”, “pricing”, “misrepresentation”, “poor service”, “shipping”, “technical problem”, “product safety”, and “unethical behavior”. In addition, the user can select a type for the resolution sought, from “apology”. “compensation”, “improvement”, “policy change”, “refund”, “repair”, and “replacement”.

FIG. 22C shows the portion of the issue registration screen 800 after completion of the issue type pop-up control 820 showing a summary of the types entered in the control.

FIG. 22D shows the portion of the issue registration screen 800 after activation of a sign in button 824. A sign up button 828 is not activated. Upon activation of the sign in button 824, a login credentials pop-up control 832 enables a user to enter in their login credentials, namely a user name or email, and a password. Optionally, the user can use a single sign-on service provider, such as Twitter, Google, or Facebook to store and provide the login credentials.

FIG. 22E shows the portion of the issue registration screen 800 after user log in. A user panel pop-up control 836 enables a user to see how much of their profile has been completed, see how many messages they have on the site, view how much credit they have, and view their activity on the site.

FIG. 22F shows the portion of the issue registration screen 800 after activation of the sign up button 828 showing a registration pop-up control 840. The registration pop-up control 840 enables a user to select a username, and enter private information, contact information in this case, in the form of an email address, and enter a password. Upon completion of the registration pop-up control 840, an email is sent to the user at the specified email address. FIG. 22G shows the portion of the issue registration screen 800 after an email confirmation message is sent by the computer system to the specified email address. An email confirmation notification 844 directs the user to check their email to verify their email address. Upon confirmation of their email address by activating a control in the confirmation email sent to them, the user is deemed registered and can register the issue via an issue registration button 848.

In other embodiments, the contact information can include a social networking service username that allows the user to be contacted.

Computer-executable instructions for implementing the web server, the messaging service, and/or the database system on a computer system could be provided separately from the computer system, for example, on a computer-readable medium (such as, for example, an optical disk, a hard disk, a USB drive or a media card) or by making them available for downloading over a communications network, such as the Internet.

While the account database, the company database, and the issue database are described as separate databases, those skilled in the art will appreciate that these databases may be virtual and provided via a single database.

The computer system can be configured to register issues for a single entity or for multiple entities. Where the computer system is configured to register issues for a single entity, the end-user may not need to specify the entity to which an issue being registered is related.

While the system described above is accessed by end-users via web browsers, in other embodiments, other types of applications can be employed to access the system. For example, mobile applications can be custom built to reduce communication between an end-user computing device and the computer system and may automatically log the end-user in and notify the end-user when a message is received via the messaging service.

While, in the above-described embodiment, the computer system handles issues to which an end-user would like a resolution, various aspects of the above approach can be used in to other types of issues. For example, the computer system can also enable people to post reviews of companies and other entities and/or their products and services, and the companies or other entities can elect to challenge the veracity of one or more of the reviews by asking to speak directly with the end-user about their review. Where an end-user refuses to release their contact information to the entity, the review can be flagged as possibly unvalidated or fake, and may be marked as such, hidden, and/or removed from the site. In this manner, an overall view of a company, product, or service's performance can be reviewed by potential customers.

While various time frames have been used by the system as described above, these time frames can be varied in most cases without impacting the working of the system.

While the computer system is shown as a single physical computer, it will be appreciated that the computer system can include two or more physical computers in communication with each other. Accordingly, while the embodiment shows the various components of the computer system residing on the same physical computer, those skilled in the art will appreciate that the components can reside on separate physical computers.

Although the invention has been described with reference to certain specific embodiments, various modifications thereof will be apparent to those skilled in the art. The scope of the claims should not be limited by the preferred embodiments, but should be given the broadest interpretation consistent with the description as a whole.

1. A method for determining metrics, comprising:
registering, in an issue database of a computer system, an issue associated with an entity and received from an end-user account via the computer system;
communicating, via a messaging service, a notification of the registered issue to an entity account associated with the entity;
communicating, by the computer system, an information request from the entity account to the end-user account via the messaging service for private information at least indirectly identifying an end-user associated with the end-user account; and
flagging the issue as unverified in the issue database if the private information is withheld by the end-user.

2. The method of claim 1, further comprising:
omitting the issue from a score calculated for the entity if it is unverified; and
presenting, via the web interface, the score for the entity.

3. The method of claim 1, further comprising:
including the issue for which an information request is unregistered in a score calculated for the entity; and
presenting, via the web interface, the score for the entity.

4. The method of claim 1, wherein the flagging comprises:
flagging the issue as unverified following a set period of time after the communicating of the information request.

5. The method of claim 4, wherein the flagging further comprises:
flagging the issue as verified if the private information is provided by the end-user after the set period.

6. The method of claim 1, wherein the private information comprises contact information.

7. The method of claim 6, wherein the contact information comprises one of an email address, a full name, a city of residence, a state of residence, and a telephone number.

8. The method of claim 1, wherein the private information comprises one of an entity account number and a reference number for a transaction between the end-user and the entity.

9. The method of claim 1, wherein the information request is presented to the end-user logged into the end-user account with at least one control for authorizing the entity account to access the private information if the private information has been registered by the computer system.

10. The method of claim 9, wherein the at least one control enables the end-user to authorize the entity account to access a subset of the private information.

11. The method of claim 1, further comprising:
presenting a private information input interface to the end-user enabling entry and registration of the private information.

12. The method of claim 11, wherein the presenting comprises:
presenting the private information input interface after registration of the information request if the private information is yet unregistered by the computer system.

13. A method for determining metrics, comprising:
registering, in an issue database of a computer system, an issue and an entity associated with the issue received from an end-user account associated with an end-user;
communicating, via a messaging service provided through the computer system, a notification of the registered issue to an entity account associated with the entity;
registering, by the computer system, a resolution offer indicator received from the entity account indicating that a resolution offer for the issue has been made to the end-user;
presenting a user interface to the end-user using the end-user account for receiving a score for the resolution offer;
registering the received score in the issue database; and
presenting an aggregate score for the entity calculated as a function of the score for the resolution offer.

14. The method of claim 13, further comprising:
registering, in the issue database, a subsequent resolution offer indicator received from the entity account indicating that a subsequent resolution offer for the issue has been made to the end-user;
presenting the user interface to the end-user using the end-user account for receiving a subsequent resolution offer score for the subsequent resolution offer;
registering the subsequent resolution offer score in the issue database; and
presenting the aggregate score for the entity calculated as a function of the score for the subsequent resolution offer.

15. The method of claim 13, wherein the registering of the resolution offer indicator comprises:
receiving, via the messaging service, a message and the resolution offer indicator from the entity account.

16. The method of claim 15, wherein the message is for delivery to the end-user via the messaging service.

17. The method of claim 16, wherein the message is to be posted publicly.

18. The method of claim 13, wherein the presenting the user interface comprises:
presenting the user interface to the end-user using the end-user account upon login.

19. The method of claim 18, wherein the presenting the user interface further comprises:
prohibiting further interaction by the end-user with the computer system until the score is received.

20. A computer system for determining metrics, comprising:
a processor; and
a storage storing an issue database, an account database, and computer-readable instructions that, when executed by the processor, cause the processor to:
register, in the issue database, an issue associated with an entity and received from an end-user account via the computer system;
communicate, via a messaging service, a notification of the registered issue to an entity account associated with the entity;
communicate an information request from the entity account to the end-user account via the messaging service for private information at least indirectly identifying an end-user associated with the end-user account; and
flagging the issue as unverified in the issue database if the private information is withheld by the end-user.
